(19) United States
(12) Patent Application Publication
(10) Pub. No.: US 2011/0278147 A1
(43) Pub. Date: Nov. 17, 2011

(54) KEYBOARD DEVICE

(75) Inventors: Shin-Kun LEE, Taoyuan (TW); Huang-Chun LIU, Taoyuan (TW); Sheng-Ju CHUNG, Taoyuan (TW); Yu-Jeng LIN, Taoyuan (TW); Chung-Lin TSAI, Taoyuan (TW)

(73) Assignee: Global Lighting Technologies, Inc.

(21) Appl. No.: 13/106,163

(22) Filed: May 12, 2011

(30) Foreign Application Priority Data
May 13, 2010 (TW) 099115289
Dec. 15, 2010 (TW) 099144014

(51) Int. Cl. H01H 13/70; H01H 13/02

(52) U.S. Cl. 200/5 A; 200/310

(57) ABSTRACT

A keyboard device includes at least an illuminant element, at least a pressing key element and a light guide element. The pressing key element includes a keycap reciprocating along a first axial direction when being pressed and a recovering component attached to the keycap for supporting and pushing back the keycap when not pressed. The light guide element is located at one side of the recovering component. The light guide element includes at least a light-incident part and a light-emitting part. The light-incident part is used for receiving light emitted from the illuminant element. The light-emitting part emits light along a second axial direction to the recovering component so that the recovering components guide light to the keycap, wherein the second axial direction is different to the first axial direction.

### BACKGROUND OF THE INVENTION

1. Field of the Invention

The present invention related to a keyboard device, and more particularly to an illuminated keyboard device.

2. Description of Prior Art

In order to overcome the problem that uses do not identify the keyboard or use keyboard in the low brightness or darkness environment, many species of illuminated keyboards are disclosure for using in the keyboard device using in desk top computers, laptop computers, notebook computers or network computers. The illuminated keyboards are all had an illuminant module which is embedded for emitting light to each of the key so that users can clearly identify the symbol of each keycaps and the striking locations.

In general, illuminant module of the illuminant keyboard is located under the keyboard for providing light to illuminate the keys of the keyboard.

However, the illuminant keyboard must provide an accommodating space for accommodating the illuminant module so as to increase thickness and volume of the keyboard device and this violates the development trend of thinner and smaller keyboard device nowadays.

### SUMMARY OF THE INVENTION

In order to solve the above-mentioned problem, the present invention provides a keyboard device. The keyboard device saves a space for disposing the illuminant module so as to reduce the thickness and volume of the keyboard device.

In order to solve the above-mentioned problem, the present invention provides a keyboard device. The keyboard device changes the light propagation route which is delivered from light source to the keys and reduces the distance between the light source and the keys so as to reduce the attenuation of light.

Accordingly, the present invention provides a keyboard device. The keyboard device comprises at least an illuminant element, at least a key element and a light guide element. The key element includes a keycap reciprocating along a first axial direction and a recovering component attached to the keycap for supporting and pushing back the keycap when not pressed. The light guide element is located at one side of the recovering element and the light guide element comprises at least a light-incident part for receiving light emitted from the illuminant element and at least a light-emitting part emitting light along a second axial direction to the recovering component so that the recovering component guides light to the keycap, wherein the first axial direction is different to the second axial direction.

According to a preferred embodiment of the invention, wherein the light guide element further comprises at least an intermediary part which is opposite to the light-emitting part and adjacent to the light-incident part, the intermediary part is gradually tilted toward the light-emitting part and away from the light-incident part.

According to a preferred embodiment of the invention, wherein the light guide element comprises two light-incident parts and two intermediary parts adjoined to the light-incident part, wherein the intermediary part is gradually tilted toward the light-emitting part and away from the adjacent light-incident part.

According to a preferred embodiment of the invention, wherein the recovering component comprises a linking unit with characteristics of guiding light or refracting light, a resilient colloid with characteristics of guiding light or refracting light or a spring with characteristic of reflecting light.

According to a preferred embodiment of the invention, wherein the keycap has a pressed surface having a transmissive pattern and an internal surface which is opposite to the pressed surface.

According to a preferred embodiment of the invention, the keyboard device further comprises a cover having a plurality of openings, each opening for exposing the keycap out and the cover having a second reflecting layer disposed on a surface facing the light guide element.

According to a preferred embodiment of the invention, wherein the light-emitting surface has a rough surface composed of a plurality of concaves or nodes.

According to a preferred embodiment of the invention, wherein the light guide element is plate shaped, strip shaped, circular cylinder shaped or polygon cylinder shaped.

According to a preferred embodiment of the invention, wherein the light guide element is plate shaped, the light guide element further comprising a first surface and two second surfaces respectively adjoined the first surface and having the light-incident part and the light-emitting part, and an area of each second surface is smaller than that of the first surface.

According to a preferred embodiment of the invention, wherein the light guide element is plate shaped, the light guide element further comprises a first surface having the light-emitting part and a second surface adjoined the first surface and having a light-incident part, an area of the second surface is smaller than that of the first surface.

According to a preferred embodiment of the invention, wherein the light guide element is circular cylinder-shaped, the light guide element further comprises an outer circumference surface having the light-emitting part and two circular end-surfaces adjoined to the outer circumference surface and each outer circumference surface having the light-incident part.

Moreover, the present invention further provides a keyboard device. The keyboard device comprises a keyboard module, at least an illuminant element and a light guide element. The keyboard module comprises a triggering circuit, a plurality of key strings spaced from each other. Each key string composed of multiple key elements spaced from each other. The key elements arranged at one side of the triggering circuit. Each key element comprises a keycap reciprocating along an axial direction which is perpendicular to triggering circuit and a recovering component located between the keycap and the triggering circuit for supporting and pushing back the keycap when not pressed. The light guide element is located on same side of the triggering circuit on which the recovering component is disposed and located between each two of the key strings. The light guide element comprises a light-incident part for receiving the light generated from the illuminant element and at least a light-emitting part facing the recovering component and emitting light to the recovering component along an axial direction which is parallel to the triggering circuit so that the recovering component guides light to the keycap.

According to a preferred embodiment of the invention, wherein the light guide element further comprises an intermediary part which is opposite to the light-emitting part and adjoined the light-incident part and the intermediary part is gradually tilted toward the light-emitting part and away from the light-incident part.

According to a preferred embodiment of the invention, wherein the light guide plate further comprises two opposite light-incident parts and two intermediary parts adjoined the light-incident part, wherein each intermediary part is gradually tilted toward the light-emitting part and away from the adjacent light-incident part.

According to a preferred embodiment of the invention, wherein the recovering component is a linking unit or a resilient colloid having characteristic of guiding light or refracting light or a spring having characteristic of reflecting light.

According to a preferred embodiment of the invention, the keyboard device further comprises a cover having a plurality of openings, each opening for exposing the keycap out and the cover having a second reflecting layer disposed on a surface facing the light guide element.

According to a preferred embodiment of the invention, wherein the light-emitting surface having a rough surface composed of a plurality of concaves or nodes.

According to a preferred embodiment of the invention, wherein the light guide element is plate shaped, strip shaped, circular cylinder shaped or polygon cylinder shaped.

According to a preferred embodiment of the invention, the light guide element is plate shaped, the light guide element further comprising a first surface and two second surfaces respectively adjoined the first surface and having the light-incident part and the light-emitting part, an area of each second surface is smaller than that of the first surface.

According to a preferred embodiment of the invention, the light guide element is plate shaped, the light guide element further comprises a first surface having the light-emitting part and a second surface adjoined the first surface and having a light-incident part, an area of the second surface is smaller than that of the first surface.

According to a preferred embodiment of the invention, the light guide element is circular cylinder shaped, the light guide element further comprises two circular end-surfaces and an outer circumference surface, each of the circular end-surfaces having the light-incident part, the outer circumference surface surrounded the circular end-surfaces and having the light-emitting part.

By changing the disposing of the light guide element, the present invention not only reduces the volume of the keyboard device but also reduces the cost of mechanism, thus making the keyboard light and small. On the other hand, the present invention reduces the distance between the light source and the key so as to increase the luminous efficiency.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic view and partially enlarged view of an M area of a keyboard device according to the present invention;

FIG. 2 is a partially cross sectional view taken along D1 direction shown in the FIG. 1 of the keyboard device and partial enlarged views of a front surface C1 and a back surface C2 of a keycap according to the first embodiment;

FIG. 3 shows the light propagation within the keyboard.

FIG. 4A is a partially cross sectional view taken along D1 direction shown in the FIG. 1 of the keyboard device according to the second embodiment;

FIG. 4B is a partially cross sectional view taken along D1 direction shown in the FIG. 1 of the keyboard device according to third embodiment;

FIG. 5A is a partially cross sectional view taken along D2 direction shown in the FIG. 1 of the keyboard device;

FIG. 5B is another partially cross sectional view taken along D2 direction shown in the FIG. 1 of the keyboard device;

FIG. 5C is the other partially cross sectional view taken along D2 direction shown in the FIG. 1 of the keyboard device;

FIG. 6 is bottom view of the covering plate of the keyboard device;

FIG. 7A is a top view of a light guide element according to a first embodiment;

FIG. 7B is a top view of a light guide element according to a second embodiment;

FIG. 7C is a top view of a light guide element according to a third embodiment;

FIG. 7D is a top view of a light guide element according to a fourth embodiment;

FIG. 7E is a perspective view of a light guide element according to a fifth embodiment;

FIG. 7F is a perspective view of a light guide element according to a sixth embodiment;

FIG. 7G is a perspective view of a light guide element according to a seventh embodiment;

FIG. 7H is a perspective view of a light guide element according to an eighth embodiment.

### DETAILED DESCRIPTION OF THE INVENTION

The present invention now will be described more fully hereinafter with reference to the accompanying drawings, in which embodiments of the invention are shown. However, it will be appreciated by those skilled in the art that alterations and modifications may be made in these embodiments without departing from the spirit and scope of the present invention.

According to the traditional illuminated keyboard device, the illuminant module is disposed under the keyboard, so the illuminated keyboard device must have an additional space for accommodating the illuminant module, guiding to the illuminated keyboard device effectively reduce the thickness and this violates the development trend of thinner and smaller of the keyboard device. Therefore, the present invention provides a keyboard device. By changing the location of the light guide element of the keyboard device to be located between each to key strings and the light propagation route of propagating light via the recovering component, and then achieve the purpose of illuminating the keycap.

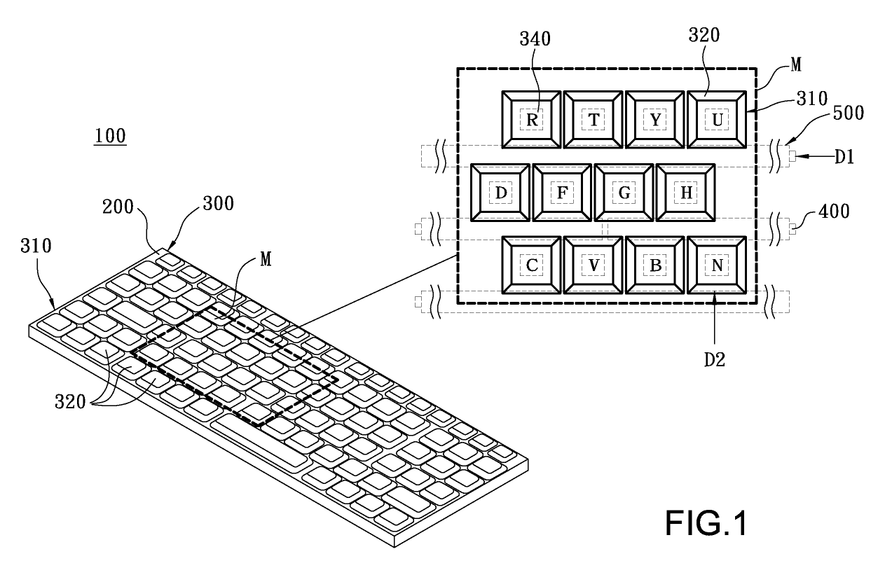

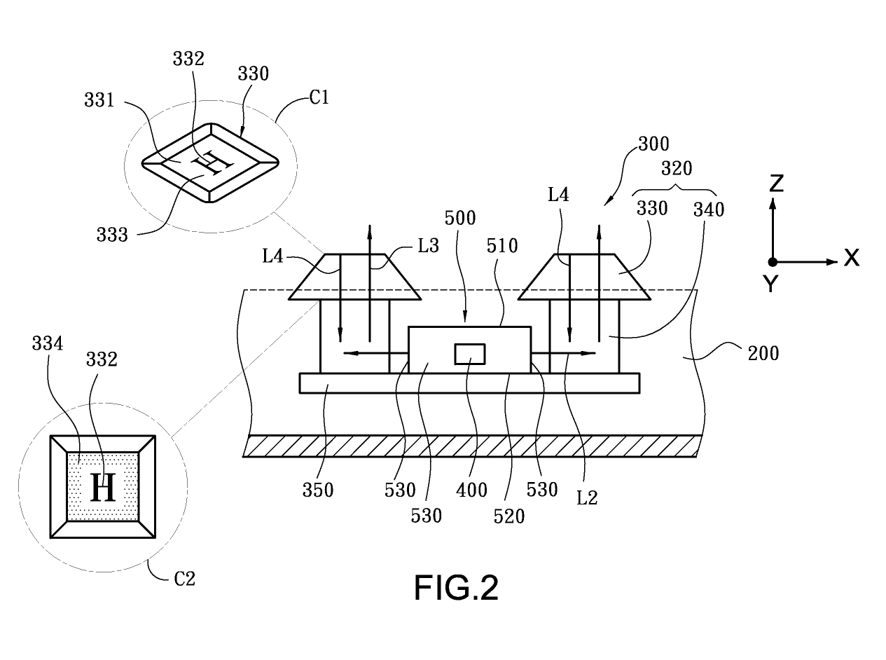

Referenced is made to FIG. 1 and FIG. 2, FIG. 1 is a schematic view and partially enlarged view of an M area of a keyboard device according to the present invention, FIG. 2 is a partially cross sectional view taken along D1 direction shown in the FIG. 1 of the keyboard device and partially enlarged views of a front surface C1 and a back surface C2 of a keycap according to the first embodiment of the present invention. The keyboard device 100 includes a casing 200, a keyboard module 300, a plurality of illuminant elements 400 and a plurality of light guide elements 500 (as shown in the M area of the FIG. 1).

The casing 200 is used for accommodating the keyboard module 300, the illuminant elements 400 and the light guide elements 500. The casing 200 can be a shell of a keyboard device 100 or a frame for supporting the keyboard module 100.

The keyboard module 300 is located within the casing 200 and includes a triggering circuit 350 and a plurality of key strings 310 spaced from each other. One side of the key string 310 is exposed to the surface of the casing 200 and another side of the key string 310 is located on one side of the triggering circuit 350. Each key string 310 is composed of multiple key elements 320 spaced from each other and arranged in linear fashion.

Each key element 320 includes a keycap 330 and a recovering component 340. Each keycap 330 is exposed to the surface of the casing 200. The recovering component 340 for supporting the keycap 330 is located within the casing 200 and set between the keycap 330 and the triggering circuit 350. The keycap 330 has a pressing surface 331 (as the front surface C1 shown in the FIG. 2). The pressing surface 331 has a transmissive pattern 332 and an opaque area 333. The transmissive pattern 332 may be character symbols, numeral symbols, symbols of geometric from or combination of the above. The opaque area 333 is an area which is opposite to the transmissive pattern 332 of the pressing surface 331 of the keycap 330.

When the keycap 330 is pressed, the keycap 330 is moved toward the triggering circuit 350 along a first axial direction (such as Z axis) which is perpendicular to the triggering circuit 350 and presses the recovering component 340 to strike a position of the triggering circuit 350 which is located under the pressed keycap 330. Then, the trigger circuit 350 provides a signal representing the symbol of the pressed keycap 330. After pressing the keycap 330, the recovering component 330 recovers the keycap 330 along the first axial direction (Z axial) to the original position while the keycap 330 is not pressed.

The light guide element 500 and the recovering component 340 are located at the same side of the triggering circuit 350 and the light guide plate 500 is located between each two of the key strings 310. Moreover, the light guide element 500 is of elongated shape so that the light guide element 500 may be located between the key elements 320 and the recovering components 340 of each two of the key strings 310 (shown in FIG. 1). The light guide element 500 and the recovering component 340 are substantially located in a same level surface. In this embodiment, the light guide element 500 can be slightly lower than the recovering component 340 as long as the light-emitting part of the light guide element 500 can still emit light L2 to the recovering component 340.

In this embodiment, the light guide element 500 is of plate shape (namely, the light guide element 500 is a light guide plate) and has a first surface 510, a second surface 520 which is opposite to the first surface 510 and four third surfaces 530 surrounded and connected to the first surface 510 and the second surface 520. The third surface 530 is a surface which can present the thickness of the light guide element 500 and the area of each third surface 530 is smaller than that of the first surface 510 or the second surface 520.

Referring to FIG. 2, the third surface 530 includes a light-incident part facing the illuminant element 400 and two light-emitting parts respectively facing the recovering components 340 located between two sides of the light guide element 500.

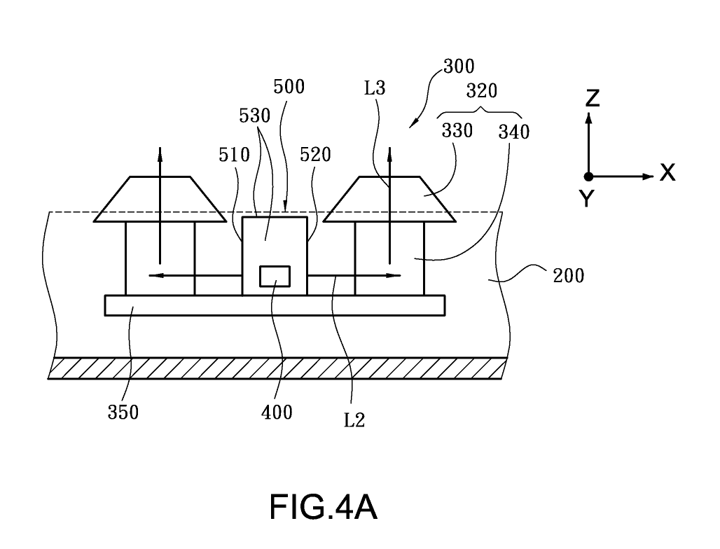

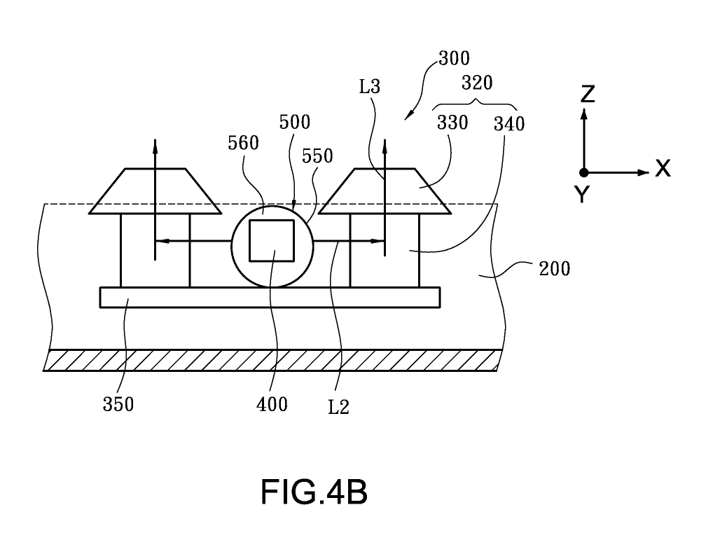

Referenced is made to FIG. 4A, which is a partially cross sectional view taken along D1 direction shown in the FIG. 1 of the keyboard device according to the second embodiment.

In this embodiment, the light guide element 500 is of plate shape (namely, the light guide element 500 is a light guide plate). The light guide element 500 includes two opposite first surfaces 510 and a second surface 520. Not only the first surface 510 but the second surface 520 has a light-emitting part. The two light-emitting parts are facing the recovering components 340 located between two sides of the light guide element 500. One of the third surfaces 530 connected to the first surface 510 and the second surface 520 has a light-incident part faced the illuminant element 400.

In this embodiment, a light guide element 500 is disposed between each two of the keyboard string 310. The illuminant element 400 is a light emitting diode and disposed at an extreme of a light guide element 500 (as the upper light guide element shown in the M area of FIG. 1). The present invention is not limited by the embodiment said above. The keyboard may arrange multiple light guide element 500 in a linear line while the keyboard is over-length (as the middle light guide element shown in the M area of FIG. 1) and the illuminant element 400 which is light emitting diode is disposed on the opposite side of the light-incident part. Furthermore, the light guide element 500 can be disposed only on one side of a single keyboard string 310 (as the lower light guide element shown in the M area of FIG. 1).

The keyboard device 100 of the present invention is working in the above various examples, each illuminant element 400 generates light L1 emitted along a third axial direction (such as Y axis) and emitted to the light-incident part of the light guide element 500. Each light-emitting part of the light guide element 500 emits light L2 to the recovering components 340 along a second axial direction (such as X axis). The recovering components 340 is made by a material with of light guiding or light reflecting characteristic to guide or divert light L3 to the keycaps 330 so as to light the transmissive pattern 332 of the pressing surface 331 of each keycap 330 (as shown in FIG. 2).

Moreover, a reflecting plate or reflecting membrane (not shown) may be disposed or coated on the first surface 510 connected to the third surface 530 of the light guide element 500 or the third surface 530 connected to the first surface 510 and the second surface 520. The reflecting plate or the reflecting membrane reflects light escaped from the light guide element 500 into the light guide element 500 again along a the first axial direction (Z axial)

It should be noted that whether the second axial direction is parallel to the triggering circuit 530 or not is decided by the angle of light L2 emitting from the light-emitting part of the light guide element 500. In the present invention, the angle of the light L2 is not limited, as long as the light L2 emitting from the light-emitting part of the light guide element 500 can be delivered to the recovering component 340 and then the recovering component 340 can deliver light L3 to the corresponding key cap 330. However, the light guide element 500 is not disposed below the recovering component 340 so the second axial direction is different to the first axial direction (Z axis).

Referenced is made to FIG. 4B, which is a partially cross sectional view taken along D1 direction shown in the FIG. 1 of the keyboard device according to third embodiment. The light guide element 501 is of circular cylinder shape, such as light guide cylinder. The light guide element 501 includes an outer circumference surface 550 and two circular end-surfaces 560. Each circular end-surface 560 is disposed on two terminal of the light guide element 501 and has a light-incident part. The outer circumference surface 550 surrounds the circular end-surfaces 560 and has a light-emitting part.

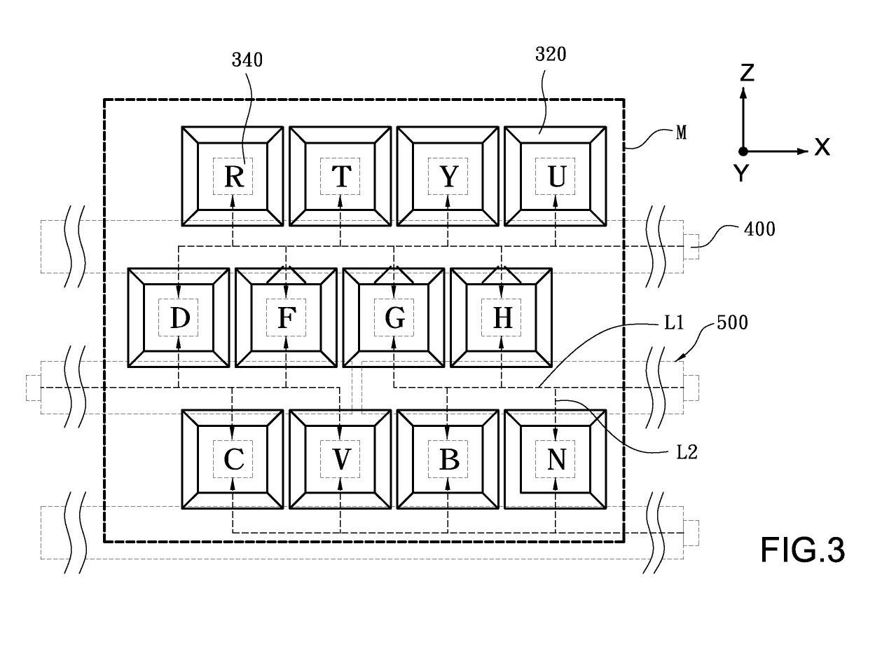

In the various examples for the keyboard device 100 of the present invention mentioned above, each illuminant element 400 generates light L1 (shown in FIG. 3) emitted to the light-incident part of light guide element 501 along a third axial direction (such as Y axis) and the light-emitting part of the light guide element 501 emits light L2 to the recovering component 340 along a second axial direction (such as X axis). The recovering components 340 which are made by material with light guiding or light reflecting characteristic guide or divert light L3 to the keycap 330 so as to light the transmissive pattern 332 of the pressing surface 331 of each keycap 330.

However, the light guide element is not limited to plate shape or circular cylinder shape, and may be other polygon cylinders, such as triangular cylinder, hexagon cylinder, heptagon cylinder or octagon cylinder.

Referring to FIG. 2, in another variation of the keyboard device 100 of the present invention, a first reflecting layer 334 (shown in the back surface C2 of FIG. 2) is disposed on the inner surface of the pressing surface 331 of each keycap 330 on which the transmissive pattern 332 is not present (namely, the opaque area 333). The first reflecting layer 334 reflects light L4 to the recovering component 340 so the recovering component 340 can guide or reflect light L3 to the keycap 330 again and promote the probability of light L3 output from the transmissive pattern 332.

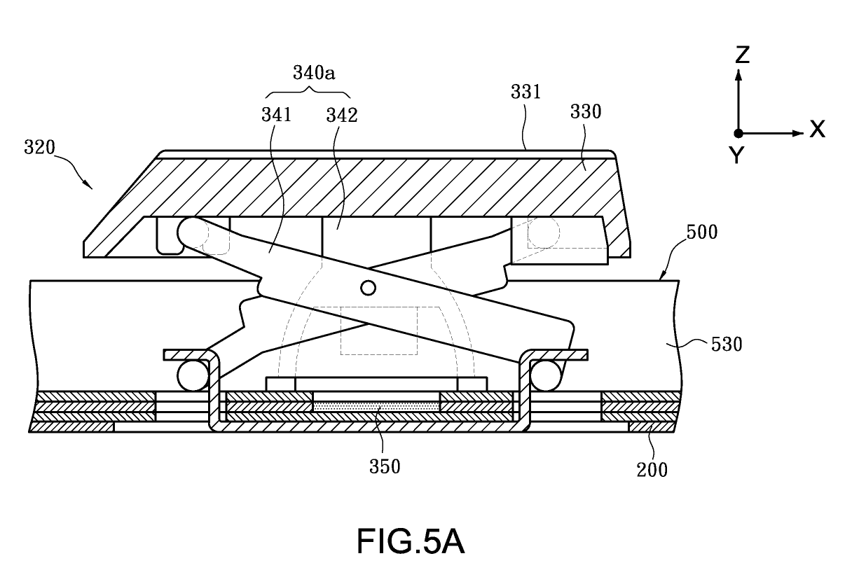

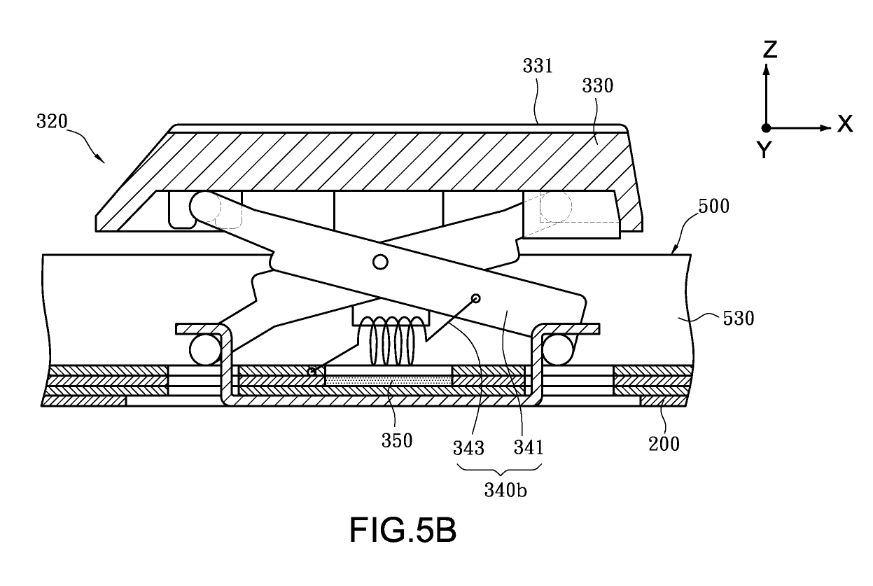

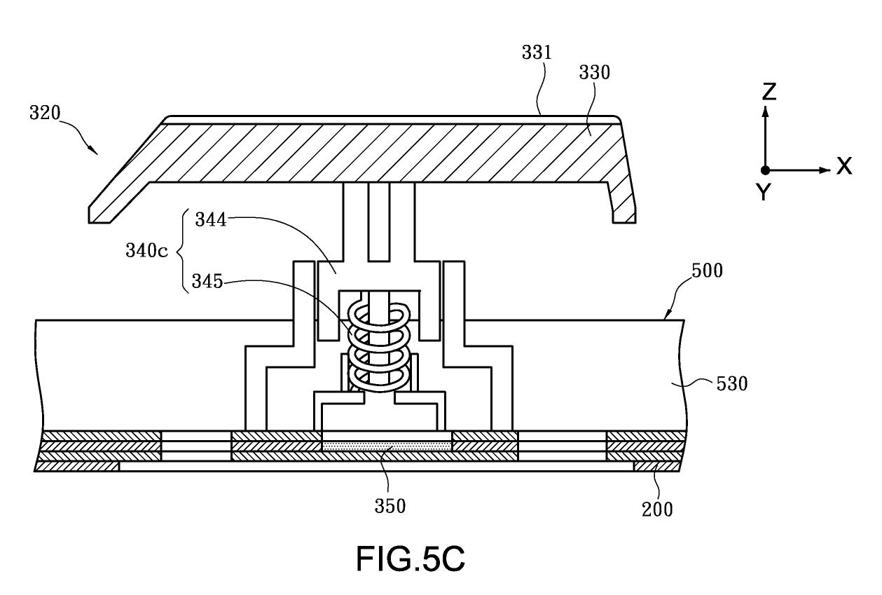

Referenced is made to FIG. 5A, which is a partially cross sectional view taken along D2 direction shown in the FIG. 1 of the keyboard device. In this embodiment, the recovering component 340a may be a linking unit 341 (such as scissors-structure key switch), resilient colloid 342 (such as conductive colloid) or the combinations of both. In the combinations of both, the keycap 330 is connected to one end of the linking unit 341 and another end of the linking unit 341 is connected to a fixed member (such as casing 200). The resilient colloid 342 drives the linking unit 341 to push the keycap 330 to the original position as the keycap 330 is not pressed.

Specifically, the linking unit 341 is made of plastic had characteristics of guiding light or refracting light so that the linking unit 341 may guide light or refract light. The plastic may be polyethylene Terephthalate (PET), polycarbonate (PC) or Poly methyl methacrylate (PMMA). The manufacturing material of resilient colloid 342 includes a soft colloid which can guide or refract light, so the resilient colloid 342 has a characteristic which can guide or refract light. The soft glue may be transparent material such as silica gel, gel, polyethylene with lower density, enprene (TPE), polyvinylchloride (PVC) or Thermoplastic Polyurethane (TPU).

Because the manufacturing material of the striking rod 344 or the resilient colloid 342 has a characteristic of guiding light L2, so that the linking unit 341 or the resilient colloid 342 changes the propagation route along which the light emits from the light guide element 500, thus maintain the light emitting efficiency of the light guide element 500.

Referenced is made to FIG. 5B, which is another partially cross sectional view taken along D2 direction shown in the FIG. 1 of the keyboard device. The recovering component 340b may be a linking unit 341 (such as scissors-structure key switch), a metallic spring 343 or combinations of the both. In the combinations of both, the keycap 330 is connected to one end of the linking unit 341, another end on the linking unit 341 is connected to a fixed member (such as casing 200). The metallic spring 343 drives the linking unit 341 to push the keycap 330 to the original position as the keycap 330 is not pressed.

Specifically, the manufacturing material of the linking unit 341 is as mentioned above. The metallic spring has a characteristic of reflecting light and can be made of high reflectivity metal, such as copper or aluminum.

Because the manufacturing material of the linking unit 341 has a characteristic of guiding light L2 and the manufacturing material of the metallic spring 343 has a characteristic of reflecting light L2 as well, the linking unit 341 or the metallic spring 345 changes the propagation route along which the light emits from the light guide element 500, thus promoting the utilization rate of light emitted from the light guide element 500.

Referenced is made to FIG. 5C, which is the other partially cross sectional view taken along D2 direction shown in the FIG. 1 of the keyboard device. In this embodiment, the recovering component 340c may be combinations of a striking rod 344 and a metallic spring 345. The keycap 330 is connected to one end of the striking rod 344 and the metallic spring 345 is connected to another end. The metallic spring 345 pushes the striking rod 344 and the keycap 330 to the original position as the keycap 330 is not pressed.

Specifically, the striking rod 344 may be made of light guiding plastic as mentioned above and the material for making the metallic spring as mentioned above as well.

Because the manufacturing material of the striking rod 344 has a characteristic of guiding light L2 and the manufacturing material of the metallic spring 345 has a characteristic of reflecting light L2 as well, the linking unit 341 or the metallic spring 345 changes the propagation route along which the light emits from the light guide element 500, thus maintaining the light emitting efficiency of the light guide element 500.

However, the recovering component 340 mentioned above is only example for the keyboard device 100 of the present invention, other element that can change light propagation route in the light guide element 500, such as recovering component 340 with mirror like surface, can also be used.

Furthermore, the type of the keyboard device 100 of the present invention is not limited to independent keyboard device 100 (such as wired or wireless keyboard device) or embedding type keyboard assembled into the portable electronic device. And the classification of the keyboard device is not limited to general keyboard, Chiclet keyboard, island-style keyboard or floating keyboard as well.

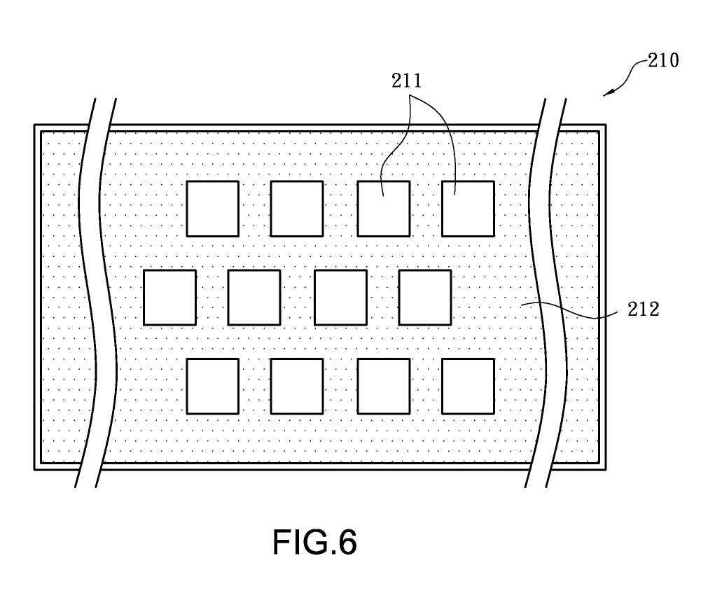

Referenced is made to FIG. 6, which is bottom view of the covering plate of the keyboard device. The keyboard device 100 further includes a covering plate 210. The covering plate 210 covered one side of the casing 200 on which the keyboard strings 310 are present. The covering plate 210 has a plurality of opening 211 for allowing the keycap 330 to extrude out. The cover plate 210 further includes a second reflecting layer 212 facing the light guide element 500. The second reflecting layer 212 reflects light escaped from the light guide element 500 back to the light guide element 500 or the recovering component 340 along the first axial direction (as Z axis shown in FIG. 2). The light guide element 500 emits light L2 to the recovering component 340 to promote the probability of light L3 outputting from the transmissive pattern 332.

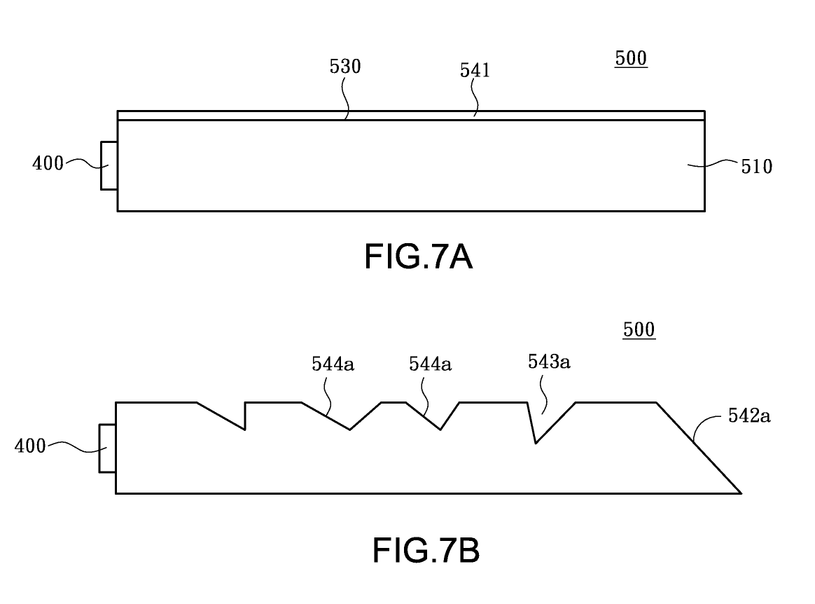

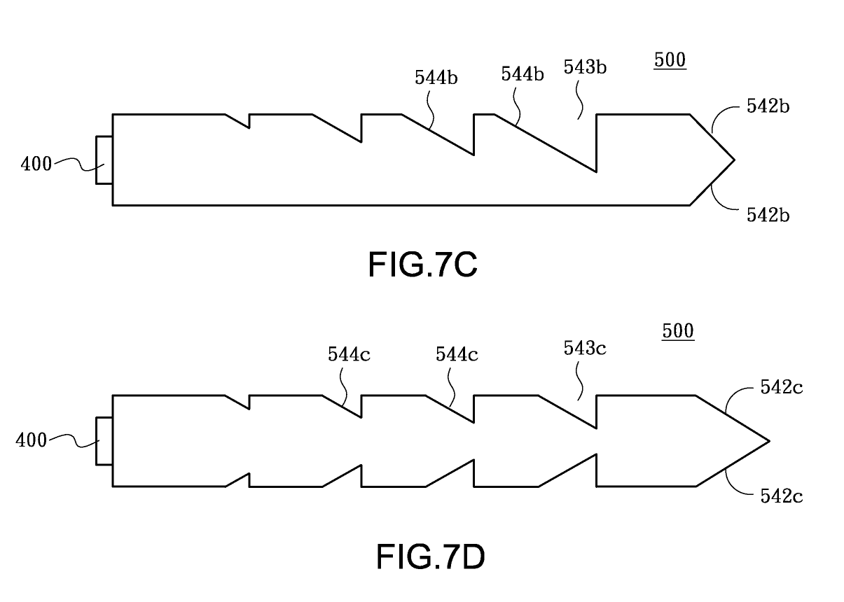

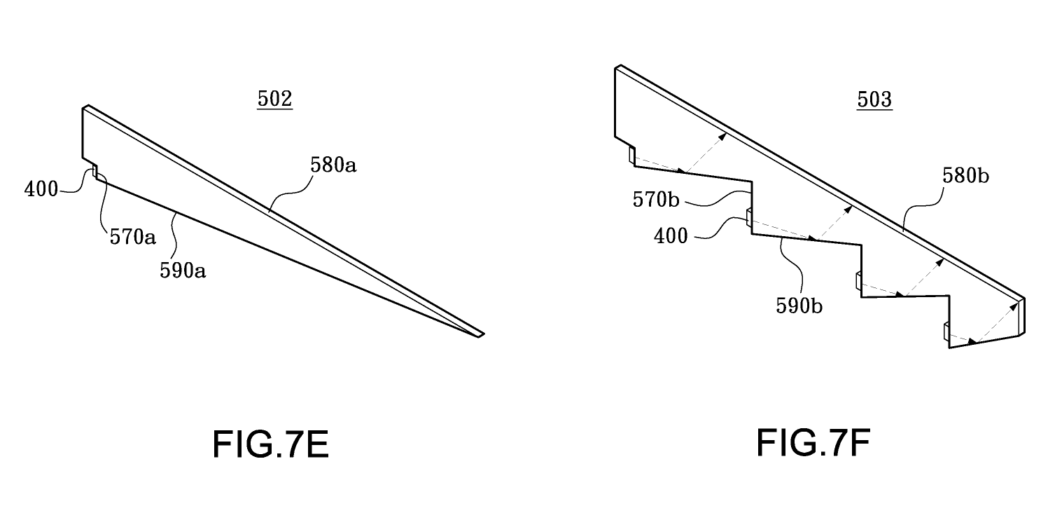

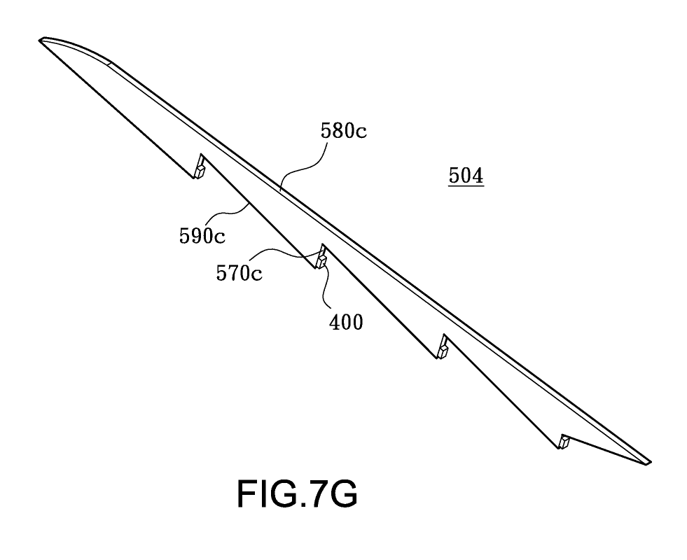

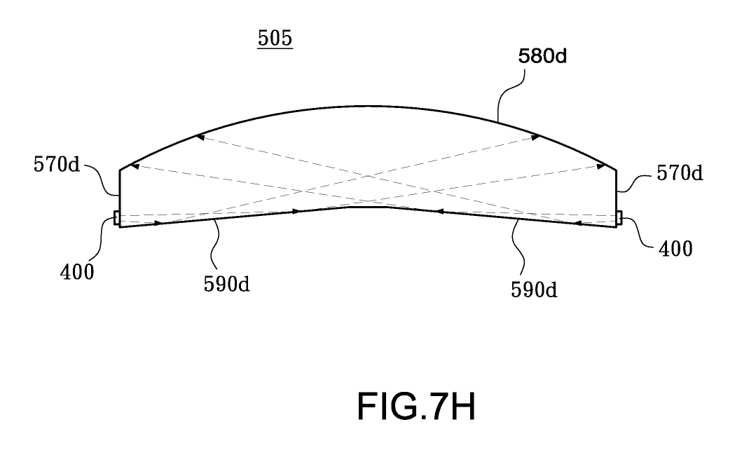

Referenced is made to FIG. 7A, which is a top view of a light guide element according to a first embodiment. In this embodiment, the light guide element 500 is of rectangular shape plate body and one of the third surfaces 530 is a light-emitting part of the light guide element 500. Referring to the FIG. 2 again, the light guide element 500 is disposed on the triggering circuit 350 and the light-emitting part is faced the recovering component 340 and emitting light L2 thereto.

In this embodiment, the light-emitting part is a rough surface. Comparing to the smooth surface, the rough surface can provides a light with higher uniform to the recovering component 340. The rough surface may be composed of multiple concave parts or multiple nodes, wherein the rough surface with concave parts is one of the embodiments of irregular plane.

In a variation embodiment of the present invention, the rough surface of the light-emitting part of the light guide element 500 may be formed by printing or coating multiple nodes or rubbing or scraping the surface of the light-emitting part.

Referenced is made to FIG. 7B, which is a top view of a light guide element according to a second embodiment. In another variation embodiment of the present invention, the rough surface of the light guide part may be form by the concave part.

In this embodiment, the light guide element 500 is of wedge shape. And one of the third surfaces 530 which is far away form the illuminant element 400 of the light guide element 500 has an inclined surface 542a. The light guide element 500 has multiple concave 543a disposed of one side of the light-emitting part, and each concave 543a has a refracting surface 544a. The depth of the each concave is different to each other and the refracting surfaces 544a may be parallel or may not be parallel.

Reference to FIG. 2 again, the light guide element 500 is disposed on the triggering circuit 530. The light-emitting part which has the concaves 543a faces the recovering component 340 and emits light to the recovering component 340. The light guide element 500 outputs more light L2 to the recovering component 340 due to the concaves 543a and increases the luminous efficiency.

Referenced is made to FIG. 7C, which is a top view of a light guide element according to a third embodiment. In this embodiment, the light guide element 500 has two inclined surface 542b adjoined each other. The light-emitting part of the light guide element 500 has multiple concaves 543b and each concave 543b has a refracting surface 544b, wherein the depths of the concaves 543b are progressively increased toward the direction had the incline surfaces 542b. The refracting surface 544b of each concave 543b may be parallel to the incline surface 542c or not. Referring to FIG. 2, simultaneously, the light guide element 500 is disposed on the triggering circuit 530 and the two sides having the concaves 543b of the light-emitting part face the recovering component 340. The light-emitting part of the light guide element 500 emits light L2 to the recovering component 340 via the concaves 543b.

Referenced is made to FIG. 7D, which is a top view of a light guide element according to a fourth embodiment. In this embodiment, the light guide element 500 has two connecting incline surfaces 542c disposed far away from the illuminant element 400. Each two side of the light-emitting part of the light guide element 500 has multiple concave 543c and each concave has a refracting surface 544c, wherein the depths of the concaves 543c are progressively increased toward the direction had the incline surfaces 542c. The refracting surface 544c of each concave 543c may be parallel to the incline surface 542c or not. Referring to FIG. 2, simultaneously, the light guide element 500 is disposed on the triggering circuit 530 and the two sides having the concaves 543c of the light-emitting part face the recovering component 340. The light-emitting part of the light guide element 500 emits light L2 to the recovering component 340 via the concaves 543c.

Referenced is made to FIG. 7E, which is a perspective view of a light guide element according to a fifth embodiment. In this embodiment, the light guide element 502 is a strip body (namely, light guide strip) and includes two opposite lateral faces and a peripheral surface surrounding the lateral faces. The peripheral surface includes a light-incident part 570a, a light-emitting part 580a and an intermediary part 590a. In this embodiment, the light-emitting part 580a is a flat surface and has micro-structure or matted structure.

The intermediary part 590a is opposite to the light-emitting part 580a and has an oblique angle with the light-emitting surface 580a. The intermediary part 590a is used for reflecting the light inputted to the light guide element 502 via the light-incident part 570a to the light-emitting part 580a. The light inputted into the light guide element 502 is modified with the light emitting amount by the oblique angle, thus achieving the effect of uniformity of illumination for the light-emitting part 580a.

The light-incident part 570a is adjoined the intermediary part 590a and perpendicular to the light-emitting part 580a. The illuminant element 400 is disposed on the light-incident part 570a and emitting light toward thereto, wherein the light-incident part 570a has micro-structures or matted structures so as to prevent light spot appearing at the light-emitting part 580a corresponding the positions where the illuminant elements 400 disposed. Moreover, the light-emitting part 580a has as micro-structures or matted structures so as to prevent light spot appearing at the light-emitting part 580a corresponding the positions where the illuminant elements 400 disposed, thus increasing the uniformity of illumination.

The light guide element 502 is disposed on the triggering circuit 530 and one lateral face of the light guide element 502 is attached to the triggering circuit 530. The light-emitting part 580a faces the recovery component 340. The light generated by the illuminant element 400 is inputted into the light guide element 502 via the light-incident part 570a and the light-emitting part emitting light L2 to the recovering component 340.

Furthermore, the light guide element 502 may respectively dispose two reflectors (not shown) on the lateral faces. The reflectors make the light generated by the illuminant element 400 and inputted into the light guide element 502 delivering to the light-emitting part 580a and emitting the light intensively from the light-emitting part for preventing light dissipation from the lateral face of the light guide element 502 and improve the overall utilization efficiency of light.

Referenced is made to FIG. 7F, which is a perspective view of a light guide element according to a sixth embodiment. The light guide element 503 is a strip body (namely, light guide strip) and includes two opposite lateral faces and a peripheral surface surrounding the lateral faces. The peripheral surface includes a plurality of light-incident parts 570b, a light-emitting part 580b and a plurality of intermediary parts 590b. In this embodiment, the light-emitting part 580b is a flat surface and used for emitting light entered the light guide element 503, wherein the light-emitting part 580b has micro-structure or matted structure.

The intermediary parts 590b are opposite to the light-emitting part 580b and the parallel to each other. The light-incident parts 570b are parallel to each other and adjoined the intermediary parts 590b. The intermediary parts 590b and the light-emitting parts 580b are interlaced and form a zigzag, wherein the light-incident part 570b is perpendicular to the light-emitting part 580b. The illuminant elements 400 are disposed on the light-incident parts 570b and emit light thereto. The light inputted into the light guide element 503 via the light-incident part 570b are reflected to the light-emitting part 580b by the intermediary part 590b and emitted outside of the light guide element 503 by the light-emitting part 580b. The light-incident parts 570b having micro-structures or matted structure to prevent light spots appear at the light-emitting part 580b corresponding to the positions where the illuminant elements 400 disposed.

The light guide element 503 is disposed on the triggering circuit 530 and one lateral face of the light guide element 503 is attached to the triggering circuit 530. The light-emitting part 580b is faced the recovery component 340. The light generated by the illuminant element 400 is emitted to the light guide element 503 via the light-incident part 570b and the light-emitting part 580b delivers light L2 to the recovering component 340.

Referenced is made to FIG. 7G, which is a perspective view of a light guide element according to a seventh embodiment. The light guide element 504 is a strip body (namely, a light guide strip) and includes two opposite lateral faces and a peripheral surface surrounding the lateral faces. The peripheral surface includes a plurality of light-incident parts 570c, a light-emitting part 580c and a plurality of intermediary parts 590c, wherein the light emitting part 580c is design as an arc surface.

The intermediary parts 590c are opposite to the light-emitting part 580c and the parallel to each other. The light-incident parts 580c do not face the light-emitting parts 580c. The light-incident parts 570c are parallel to each other and adjoined the intermediary parts 590c. The intermediary parts 590c and the light-emitting parts 580c are interlaced and form a zigzag, wherein the light-incident part 570c is perpendicular to the light-emitting part 580c. The light-emitting part 580c is designed as arc surface so that one of the intermediary parts 590c is adjacent to the light-emitting part 580c. The illuminant elements 400 are disposed on the light-incident parts 570c and emit light thereto. The light inputted by the light-incident part 570c are reflected to the light-emitting part 580c by the intermediary part 590c and then emitted by the light-emitting part 580c.

The light guide element 504 is disposed on the triggering circuit 530 and one lateral face of the light guide element 504 is attached to the triggering circuit 530. The light-emitting part 580c faces the recovery component 340. The light generated by the illuminant element 400 is emitted to the light guide element 504 via the light-incident part 570c and the light-emitting part 580c delivers light L2 to the recovering component 340.

Referenced is made to FIG. 7H, which is a perspective view of a light guide element according to an eighth embodiment. The light guide element 505 is a strip body (namely, a light guide strip) and includes two opposite side-surfaces and a peripheral surface. The peripheral surface includes a first light-incident part 570d, a second light-incident part 571d, an arc light-emitting part 580d and two intermediary parts 590d.

The first light-incident part 570d faces the second light incident-part 571d. The first light-incident part 570d and the second light-incident part 571d are adjoined the intermediary parts 590d and the light-emitting part 580d, respectively. At least an illuminant element 400 is respectively disposed on the first light-incident part 570d and the second light-incident part 571d and the illuminant elements 400 emit light thereto.

The intermediary parts 590d are opposite to the light-emitting part 580d and the intermediary part 590d is gradually tilted toward the light-emitting part from the first light-incident part 570d and the second light-incident part 571d so that the intermediary parts 590d is an arc surface shaped or wing shaped. The light generated by the two illuminant elements 400 and injected into the light guide element 505 are reflected to the light-emitting part 580d by the intermediary part 590d and then emitted by the light-emitting part 580d.

The light guide element 505 is disposed on the triggering circuit 530 and one lateral face of the light guide element 505 is attached to the triggering circuit 530. The light-emitting part 580d is faced the recovery component 340. The light generated by the illuminant element 400 is emitted to the light guide element via the light-incident part 570d and the light-emitting part 580d delivers light L2 to the recovering component 340.

However, the light guide element is not limited to the application for the keyboard device, and may be used as a decorate lighting, such as a casing of computer mainframe to increase artistic of the casing.

In conclusion, by changing the disposing of the light guide element, the present invention not only reduces the volume of the keyboard device but also reduces the cost of mechanism, thus making the keyboard light and small. On the other hand, the present invention reduces the distance between the light source and the key so as to increase the luminous efficiency.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A keyboard device, comprising:
at least an illuminant element;
at least a pressing key element, comprising:
a keycap reciprocating along a first axial direction;
a recovering component attached to the keycap for supporting and pushing back the keycap when not pressed; and
a light guide element located at one side of the recovering element, the light guide element comprising:
at least a light-incident part for receiving light emitted from the illuminant element;
a light-emitting part emitting light along a second axial direction to the recovering component so that the recovering component guides light to the keycap, wherein the first axial direction is different to the second axial direction.

2. The keyboard device in claim 1, wherein the light guide element further comprises at least an intermediary part which is opposite to the light-emitting part and adjacent to the light-incident part, the intermediary part is gradually tilted toward the light-emitting part and away from the light-incident part.

3. The keyboard device in claim 2, wherein the light guide element comprises two light-incident parts and two intermediary parts adjoined to the light-incident part, wherein the intermediary part is gradually tilted toward the light-emitting part and away from the adjacent light-incident part.

4. The keyboard device in claim 1, wherein the recovering component comprises a linking unit with characteristics of guiding light or refracting light, a resilient colloid with characteristics of guiding light or refracting light or a spring with characteristic of reflecting light.

5. The keyboard device in claim 1, wherein the keycap has a pressed surface having a transmissive pattern and an internal surface which is opposite to the pressed surface.

6. The keyboard device in claim 1, further comprising:
a cover having a plurality of openings, each opening for exposing the keycap out and the cover having a second reflecting layer disposed on a surface facing the light guide element.

7. The keyboard device in claim 1, wherein the light-emitting surface has a rough surface composed of a plurality of concaves or nodes.

8. The keyboard device in claim 1, wherein the light guide element is plate shaped, strip shaped, circular cylinder shaped or polygon cylinder shaped.

9. The keyboard device in claim 8, wherein the light guide element is plate shaped, the light guide element further comprising:
a first surface, and
two second surfaces respectively adjoined the first surface and having the light-incident part and the light-emitting part, and an area of each second surface is smaller than that of the first surface.

10. The keyboard device in claim 8, wherein the light guide element is plate shaped, the light guide element further comprising:
a first surface having the light-emitting part, and
a second surface adjoined the first surface and having a light-incident part, an area of the second surface is smaller than that of the first surface.

11. The keyboard device in claim 8, wherein the light guide element is circular cylinder shaped, the light guide element further comprising:
an outer circumference surface having the light-emitting part, and
two circular end-surfaces adjoined to the outer circumference surface and each outer circumference surface having the light-incident part.

12. A keyboard device, comprising:
a keyboard module, comprising:
a triggering circuit;
a plurality of key strings spaced from each other, each key string composed of multiple key elements spaced from each other, the key elements arranged at one side of the triggering circuit, each key element comprising:
a keycap reciprocating along a axial direction which is perpendicular to triggering circuit;
a recovering component located between the keycap and the triggering circuit for supporting and pushing back the keycap when not pressed;
at least an illuminant element;
a light guide element located on same side of the triggering circuit on which the recovering component is disposed and located between each two of the key strings, the light guide element comprising:
a light-incident part for receiving the light generated from the illuminant element;
at least a light-emitting part facing the recovering component and emitting light to the recovering component along an axial direction which is parallel to the triggering circuit so that the recovering component guides light to the keycap.

13. The keyboard device in claim 12, wherein the light guide element further comprises an intermediary part which is opposite to the light-emitting part and adjoined the light-incident part, the intermediary part is gradually tilted toward the light-emitting part and away from the light-incident part.

14. The keyboard device in claim 13, wherein the light guide plate further comprises two opposite light-incident parts and two intermediary parts adjoined the light-incident part, wherein each intermediary part is gradually tilted toward the light-emitting part and away from the adjacent light-incident part.

15. The keyboard device in claim 12, wherein the recovering component is a linking unit or a resilient colloid having characteristic of guiding light or refracting light or a spring having characteristic of reflecting light.

16. The keyboard device in claim 12, further comprising:
a cover having a plurality of openings, each opening for exposing the keycap out and the cover having a second reflecting layer disposed on a surface facing the light guide element.

17. The keyboard device in claim 12, wherein the light-emitting surface having a rough surface composed of a plurality of concaves or nodes.

18. The keyboard device in claim 12, wherein the light guide element is plate shaped, strip shaped, circular cylinder shaped or polygon cylinder shaped.

19. The keyboard device in claim 18, the light guide element is plate shaped, the light guide element further comprising:
a first surface, and
two second surfaces respectively adjoined the first surface and having the light-incident part and the light-emitting part, an area of each second surface is smaller than that of the first surface.

20. The keyboard device in claim 18, the light guide element is plate shaped, the light guide element further comprising:
a first surface having the light-emitting part, and
a second surface adjoined the first surface and having a light-incident part, an area of the second surface is smaller than that of the first surface.

21. The keyboard device in claim 18, the light guide element is circular cylinder shaped, the light guide element further comprising:
two circular end-surfaces, each of the circular end-surfaces having the light-incident part; and
an outer circumference surface surrounded the circular end-surfaces and having the light-emitting part.
